(19) United States
(12) Patent Application Publication
(10) Pub. No.: US 2026/0261278 A1
(43) Pub. Date: Sep. 3, 2026

(54) PSAM CARD AUTOMATIC IDENTIFICATION AND DISPLAY METHOD AND DEVICE

(71) Applicant: Feitian Technologies Co., Ltd., Beijing (CN)

(72) Inventor: Zhou LU, Beijing (CN)

(73) Assignee: Feitian Technologies Co., Ltd., Beijing (CN)

(21) Appl. No.: 18/863,652

(22) PCT Filed: Mar. 21, 2023
(86) PCT No.: PCT/CN2023/082708

§ 371 Date: Nov. 7, 2024

(30) Foreign Application Priority Data
May 9, 2022 (CN) 202210496400.0

(51) Int. Cl. G06Q 20/34

(52) U.S. Cl. CPC H04B 1/3816

(57) ABSTRACT

The application provides PSAM card automatic identification and display method and device, including: a Telephony service module receiving an identification status of an SIM card reported by a Modem module, organizing and sending a system broadcast of a SIM card status changing, a Telephone process module listening to and parsing the broadcast, and if a first error SIM card status is obtained, notifying a switching circuit of a common card slot to switch and connect to a security processor; the terminal service module sending an instruction to start PSAM card detection, and a PSAMReader module performing PSAM card detection and returning a PSAM card status; the terminal service module passing the PSAM card status to the Telephony service module; which organizing the system broadcast of the PSAM card status changing, and the SystemUI module updating a display status of a PSAM card icon when listening to and receiving the broadcast.

The present application claims the priority of the Chinese patent application No. 202210496400.0, entitled “A PSAM CARD AUTOMATIC IDENTIFICATION AND DISPLAY METHOD AND DEVICE”, filed with the China National Intellectual Property Administration on May 9, 2022, the entire contents of which are incorporated by reference in the present application.

### TECHNICAL FIELD

The application relates the terminal device filed, in particular to a PSAM (Purchase Secure Access Module) card automatic identification and display method and device.

### BACKGROUND

In some usage scenarios of terminal devices, users need to know the status of PSAM cards, but at present, all Android platforms have not realized the identification of PSAM cards, so it has become an urgent technical problem to be solved at the level of Android system to improve the automatic identification of PSAM cards, realize the automatic switching between PSAM cards and SIM (Subscriber Identity Module) cards, and display the status of the recognized PSAM cards on the status bar of the terminal devices.

### SUMMARY

The application provides a PSAM card automatic identification and display method and device, and solves the above-mentioned technical problem.

In a first aspect, the application provides a method for automatic identification and display of PSAM cards, which is applied to a terminal device equipped with an application processor and a security processor, and the terminal equipment includes at least one common card slot for a PSAM card and a SIM card, including:
step A0, performing, by a Modem module, an identification operation of the SIM card, and reporting an identification status of the SIM card to a Telephony service module;
step A1, receiving, by the Telephony service module, the identification status of the SIM card reported by the Modem module, organizing and sending a system broadcast of a SIM card status changing;
step A2, parsing, by a Telephone process module, the received system broadcast, after receiving the system broadcast of the SIM card status changing, creating a first preset device node in a file system when obtaining a first error SIM card status through parsing, and writing a first preset value to the first preset device node, so as to notify a system driver to control a switching circuit of the common card slot to switch and connect to the security processor, and sending a message, that the device node has been written, to a terminal service module;
step A3, sending, by the terminal service module, an instruction to start a PSAM card detection through a serial port, after receiving the message that the device node has written;
Step A4, performing, by a PSAM reader module, the PSAM card detection, when receiving the instruction to start the PSAM card detection through the serial port, and returning a first PSAM card status through the serial port according to a detection result;
step A5, passing, by the terminal service module, the first PSAM card status to the Telephony service module, when receiving the first PSAM card status through serial port;
Step A6, after receiving the first PSAM card status, organizing and sending, by the Telephony service module, the system broadcast of the first PSAM card status changing;
Step A7, when receiving the system broadcast of the first PSAM card status changing, updating, by a SystemUI module, a display status of a first PSAM card icon in a status bar of the terminal device;
the Modem module, the Telephony service module, the Telephone process module, the terminal service module, the SystemUI module are arranged on the application processor, and the PSAMReader module is arranged on the security processor; when the terminal device is powered on, the switching circuit of the common card slot is connected to the application processor by default.

In a second aspect, the application also provides a PSAM card automatic identification and display device, which is applied to a terminal device equipped with an application processor and a security processor, and the terminal equipment includes at least one common card slot for a PSAM card and a SIM card, and the device includes:
a Modem module, configured to perform an identification operation of the SIM card, and report an identification status of the SIM card to a Telephony service module;
the Telephony service module, configured to receive the identification status of the SIM card reported by the Modem module, organize and send a system broadcast of a SIM card status changing;
a Phone process module, configured to parse the received system broadcast, after receiving the system broadcast of the SIM card status changing, create a first preset device node in a file system when obtaining a first error SIM card status through parsing, write a first preset value to the first preset device node, so as to notify a system driver to control a switching circuit of the common card slot to switch and connect to the security processor, and send a message, that the device node has been written, to a terminal service module;
the terminal service module, configured to send an instruction to start a PSAM card detection through a serial port after receiving the message that the device node has written;
the PSAMReader module, configured to perform the PSAM card detection, when receiving the instruction to start PSAM card detection through the serial port, and return a first PSAM card status through the serial port according to a detection result;
the terminal service module is further configured to pass the first PSAM card status to the Telephony service module, when receiving the first PSAM card status through the serial port;
the Telephony service module is further configured to organize and send the system broadcast of the first PSAM card status changing, after receiving the first PSAM card status;
the device also includes a SystemUI module, configured to update a display status of a first PSAM card icon in a status bar of terminal equipment, when receiving the system broadcast of the first PSAM card status changing;
the Modem module, the Telephony service module, the Telephone process module, the terminal service module and the SystemUI module are arranged on the application processor, and the PSAMReader module is arranged on the security processor; when the terminal device is powered on, the switching circuit of the common card slot is connected to the application processor by default.

In a third aspect, the application also provides an electronic device including: a processor and a memory; where,
the memory is configured to store a computer program;
the processor is configured to perform the method provided in the present application by invoking the computer program stored in memory.

In a fourth aspect, the application further provides a chip system including a processor and an interface, and the processor is configured to implement the method provided in the application through the interface.

In a fifth aspect, the application further provides a computer-readable storage medium configured to store a computer program, and when the computer program runs on a computer, the computer executes the method provided in the present application.

The beneficial effects realized by the present application are as follows: the application provides a PSAM card automatic identification and display method and device applied to the terminal equipment of dual processors, the SIM card slot connected with the application processor of the terminal equipment is shared as a PSAM card slot, to realize the automatic identification after the PSAM card is inserted into the common card slot and the access of the security processor of the terminal device to the PSAM card in the common card slot, and an interface display is provided, and the status of the PSAM card is displayed in real time on the interface according to the automatic identification result, at the same time, the automatic switching between the SIM card and the PSAM card is realized.

### BRIEF DESCRIPTION OF DRAWINGS

By reading the detailed description of the specific embodiments below, various other advantages and benefits will become clear to those of ordinary skill in the art. The drawings are used only for the purpose of showing the preferred embodiments and are not considered to be a limitation on the embodiments of the present invention. Furthermore, throughout the drawing, the same or similar designations indicate the same or similar elements or elements with the same or similar functions. In the accompanying drawing:

FIG. 1 is a flow chart of a PSAM card automatic identification and display method provided in a first embodiment of the present application.

FIG. 2 is a schematic structural diagram of a terminal device applicable to a PSAM card automatic identification and display method provided in a second embodiment of the present application.

FIG. 3 is a flow chart of a PSAM card automatic identification and display method provided in the second embodiment of the present application.

FIG. 4 is a schematic structural diagram of a PSAM card automatic identification and display device provided in a third embodiment of the present application.

### DESCRIPTION OF EMBODIMENTS

The application provides a PSAM card automatic identification and display method and device, and embodiments of the present application are further described in detail below in conjunction with the accompanying drawings. The embodiments described are illustrative and are used only to interpret the present application and not to be construed as a limitation on the present application.

Those skilled in the art may understand that, unless specifically stated, the singular form “a”, “one”, “said” and “the” used herein may also include the plural. It should be further understood that the wording “including” used in the description of the present application means the existence of said features, integers, steps, operations, components and/or components, but does not preclude the existence or addition of one or more other features, integers, steps, operations, elements, assemblies and/or groups thereof. It should be understood that when we say that a component is “connected” or “coupled” to another component, it can be connected or coupled directly to other elements, or there can also be intermediate elements. In addition, the term “connection” or “coupling” used here can include either a wireless connection or a wireless coupling. The wording “and/or” used here includes all or any unit and all combinations of one or more associated listed items. It should be understood that the expressions “first”, “second”, “third”, “fourth”, “fifth”, etc., used in this application are for the purpose of clarity and convenience and are not intended to limit the number, order or importance.

Unless otherwise defined, all terms used herein, including technical and scientific terms, have the same meanings as those commonly understood by those skilled in the art. It should also be understood that those terms, such as those defined in the General Dictionary, should be understood to have meanings consistent with the meaning in the context of prior art and not be interpreted in an idealized or overly formal meaning unless specifically defined, as is the case here.

The SIM card described in this application is an IC (Integrated Circuit) card held by a mobile user of the GSM (Global System for Mobile Communications) system, which is called a subscriber identification card; the PSAM card is a terminal security control module.

The embodiments of the present application may be combined with each other, and the same or similar concepts or processes may not be repeated in some embodiments.

### FIRST EMBODIMENT

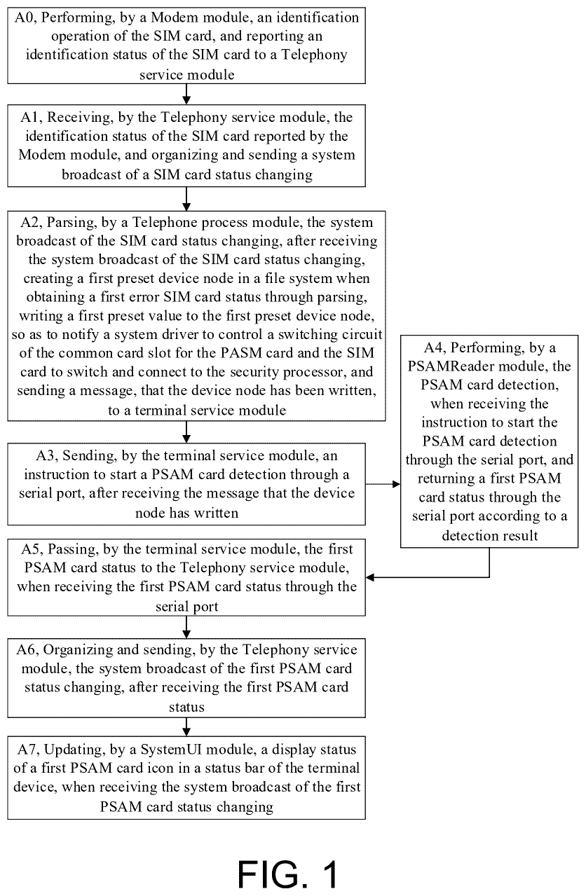

The present embodiment provides a PSAM card automatic identification and display method, which is applied to a terminal device that is provided with an application processor and a security processor, and the terminal device includes at least one common card slot for a PSAM card and a SIM card, see FIG. 1, and the method specifically includes:

Step A0, a modem module performs an identification operation of a SIM card, and reports an identification status of the SIM card to a Telephony service module;

Step A1, the Telephony service module receives the identification status of the SIM card reported by the Modem module, organizes and sends a system broadcast of a SIM card status changing;

Step A2, after receiving the system broadcast of the SIM card status changing, a Telephone process module parses the system broadcast of the SIM card status changing, creates a first preset device node in a file system when obtaining a first error SIM card status through parsing, writes a first preset value to the first preset device node, to notify a system driver to control a switching circuit of the common card slot for the PSAM card and the SIM card to switch and connect to a security processor, and sends a message, that the device node has been written, to a

Optionally, in Step S2, when parsing the system broadcast of the SIM card status changing and obtaining a correct SIM card status, performing a SIM card identification and access.

Step A3, the terminal service module sends an instruction to start PSAM card detection through a serial port, after receiving the message that the device node has been written;

Step A4, when receiving the instruction to start PSAM card detection through the serial port, a PSAMReader module performs PSAM card detection and returns a first PSAM card status through the serial port according to a detection result.

Optionally, performing PSAM card detection and returning a first PSAM card status through the serial port according to the detection result, specifically comprises: starting the PSAM card detection, reading the information of a card in the common card slot for the PSAM card and the SIM card, if the information of the card is successfully read, then returning the first preset status through the serial port, and if the information of the card fails to be read, then returning a second preset status through the serial port.

Step A5, when receiving the first PSAM card status through the serial port, the terminal service module passes the first PSAM card status to the Telephony service module.

In a possible embodiment, the terminal service module passes the first PSAM card status to the Telephony service module, specifically: the terminal service module passes the first PSAM card status to the Telephony service module through an update PSAM card status interface of a class of an external interface provided by the Telephony service module.

Step A6, after receiving the first PSAM card status, the Telephony service module organizes and sends the system broadcast of the first PSAM card status changing;

Step A7, when receiving the system broadcast of the first PSAM card status changing, a SystemUI module updates a display status of a first PSAM card icon in a status bar of the terminal device.

Optionally, when being initialized, the SystemUI module registers and listens to the system broadcast of the first PSAM card status changing, and when the Telephony service module sends the system broadcast of the first PSAM card status changing, a broadcast reception method in the implementation of a preset custom interface class of the SystemUI module is automatically called back.

In one possible embodiment, the Telephony service module organizing the system broadcast of the first PSAM card status changing includes: creating an Intent, specifying an action of the Intent, encapsulating a data structure, and storing a key-value pair of the first PSAM card status into the data structure; correspondingly, the SystemUI module registering and listening to the system broadcast of the first PSAM card status changing includes: registering and listening to the Intent of the specified action; when the broadcast receiving method of the SystemUI module is called, the SystemUI module obtains the Intent of the specified action, and obtains the first PSAM card status from the key-value pair of the first PSAM card status of the Intent by calling the system method.

In one possible embodiment, the implementation of a preset custom interface class of the SystemUI module inherits from the broadcast, the first member variable, the first PSAM status view, of the preset custom interface class includes a first icon status of the inner class, the first icon status includes a first attribute and a second attribute, the first attribute controls whether to display the attribute of the first PSAM card icon, the second attribute controls the attribute of the first PSAM card icon style, and the first PSAM status view further includes an update icon method; the SystemUI module updates the display status of the first PSAM card icon in the status bar of the terminal device as follows: calling the update icon method, and updating the first attribute and the second attribute of the first icon status according to the first PSAM card status.

The Modem module, the Telephony service module, the Phone process module, the terminal service module, the SystemUI module are arranged at an application processor of the terminal device, and the PSAMFReader module is arranged at a security processor of the terminal device; and when the terminal device is powered on, the switching circuit of the common card slot for the PSAM card and SIM card is connected to the application processor of the terminal device by default.

In one possible embodiment, in step A2, when the first error SIM card status is obtained by parsing, a second preset device node is further created in the file system and a second preset value is written to the second preset device node; in step A5, when the terminal service module receives the first PSAM card status through the serial port, it further includes writing a third preset value to the second preset device node in the file system.

Further, in step A2, when parsing the system broadcast of the SIM card status changing to obtain the second error SIM card status, the Telephone process module sends a message of querying the device node to the terminal service module; when the terminal service module receives the message of querying the device node, it reads the second preset device node in the file system, if the value of the second preset device node is the third preset value, then generates the first PSAM card status, passes the first PSAM card status to the Telephony service module, executes step A6, and if the value of the second preset device node is the second preset value, then performs the identification and access of SIM card.

In one possible embodiment, step A7 further includes: when receiving the system broadcast of the first PSAM card status changing, a system Settings module updates a status of a PSAM card switch menu. Optionally, when the display of the PSAM card switch menu is initiated, the system Settings module registers and listens to the system broadcast of the first PSAM card status changing, after the Telephony service module sends the system broadcast of the first PSAM card status changing, a preset broadcast receiving method of the system Settings module is called, and the system Settings module receives the system broadcast of the first PSAM card status changing, obtains the first PSAM card status in this broadcast; when the display of the PSAM Card Switch menu is turned off, the system Settings module cancels listening to the system broadcast of the first PSAM card status changing. The system Settings module includes a preset custom class for implementing the PSAM card switch menu, the preset custom class inherits from the system switch menu, and a custom inner class of the preset custom class includes an update menu method; the system Settings module updates the status of the PSAM card switch menu, specifically: calls the above update menu method to update the status of the PSAM card switch menu according to the first PSAM card status.

Further, after receiving the first PSAM card status, the Telephony service module further includes saving the received first PSAM card status; when being initialized, the system Settings module obtains the first PSAM card status saved by the Telephony service module from the Telephony service module, and determines the status of the PSAM card switch menu according to the first PSAM card status obtained.

Further, the method provided in this embodiment may also include performing steps C1 through C3 when the user operates the PSAM card switch menu to disable the PSAM card, and/or performing steps D1 through D3 when the user operates the PSAM card switch menu to enable the PSAM card.

Steps C1 through C3 are as follows:

Step C1, system Settings module sends a PSAM card disable notification to the Telephony service module;

Step C2, the Telephony service module updates the saved first PSAM card status to a fourth preset status, organizes and sends the system broadcast of the first PSAM card status changing, and writes the second preset value to the first preset device node in the file system, to notify the system driver to control the switch circuit of the common card slot for the PSAM card and the SIM card to switch and connect to the application processor;

Step C3, when receiving the system broadcast of the first PSAM card status changing, the SystemUI module updates the display status of the first PSAM card icon in the status bar of the terminal device, and the system Settings module updates the status of the PSAM card switch menu.

Steps D1 through D3 are:

Step D1, the system Settings module sends a PSAM card enable notification to the

Step D2, the Telephony service module updates the saved first PSAM card status to the fifth preset status, organizes and sends the system broadcast of the first PSAM card status changing, and writes the first preset value into the first preset device node in the file system to notify the system driver to control the switch circuit of the common card slot for the PSAM card and the SIM card to switch and connect to the security processor;

Step D3, when receiving the system broadcast of the first PSAM card status changing, the SystemUI module updates the display status of the first PSAM card icon of the status bar in the terminal device, and the system Settings module updates the status of the PSAM card switch menu.

In one possible embodiment, the above method further includes:

Step B1, when the PSAM card is detected to be removed from the common card slot for the PSAM card and the SIM card, the PSAMReader module sends the first PSAM card status through the serial port, and the first PSAM card status is specifically a third preset status;

Step B2, when receiving the first PSAM card status through the serial port, the terminal service module passes the first PSAM card status to the Telephony service module;

Step B3, when receiving the first PSAM card status, the Telephony service module organizes and sends the system broadcast of the first PSAM card status changing, and writes the second preset value into the first preset device node in the file system, so as to notify the system driver to control the switching circuit of the common card slot for the PSAM card and the SIM card to switch and connect to the application processor;

Step B4, when receiving the system broadcast of the first PSAM card status changing, the SystemUI module updates the display status of the first PSAM card icon in the status bar of the terminal device.

In one possible embodiment, the terminal device, to which the method provided in the present embodiment applies, further includes at least one PSAM card-specific card slot, and the method provided in the present embodiment further includes the following steps when a card is inserted in or removed from the PSAM card-specific card slot:

Step E1, the PSAMReader module performs the PSAM card detection, and sends a second PSAM card status through the serial port according to the detection result;

Step E2, when receiving the second PSAM card status through the serial port, the terminal service module passes the second PSAM card status to the Telephony service module;

Step E3, after receiving the second PSAM card status, the Telephony service module organizes and sends a system broadcast of the second PSAM card status changing;

Step E4, when receiving the system broadcast of the second PSAM card status changing, the SystemUI module updates a display status of a second PSAM card icon in the status bar of the terminal device.

### SECOND EMBODIMENT

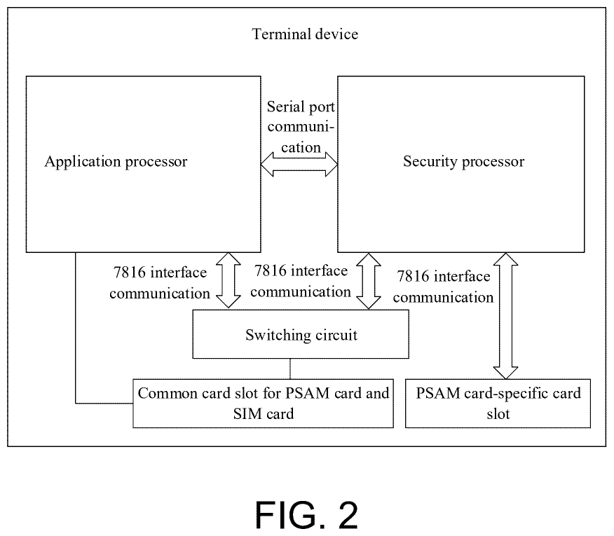

The embodiment provides a PSAM card automatic identification and display method, which is applied to a terminal equipment shown in FIG. 2, the terminal equipment including an application processor and a security processor, wherein the application processor and the security processor communicate through a serial port, and the terminal device is provided with at least one common card slot for a PSAM card and a SIM card, and the common card slot for the PSAM card and the SIM card is connected with a switching circuit. The application processor controls the switching circuit to switch the connection. When the terminal device is powered on, the switching circuit is connected to the application processor by default. When the switching circuit is connected to the application processor, the common card slot for the PSAM card and the SIM card communicates with the application processor via a 7816 interface through the switching circuit, and when the switching circuit is switched to the security processor, the common card slot for the PSAM card and the SIM card communicates with the security processor via the 7816 interface through the switching circuit. The application processor of the terminal device in the application is based on the Android platform.

The PSAM card automatic identification and display method provided in this application includes the following.

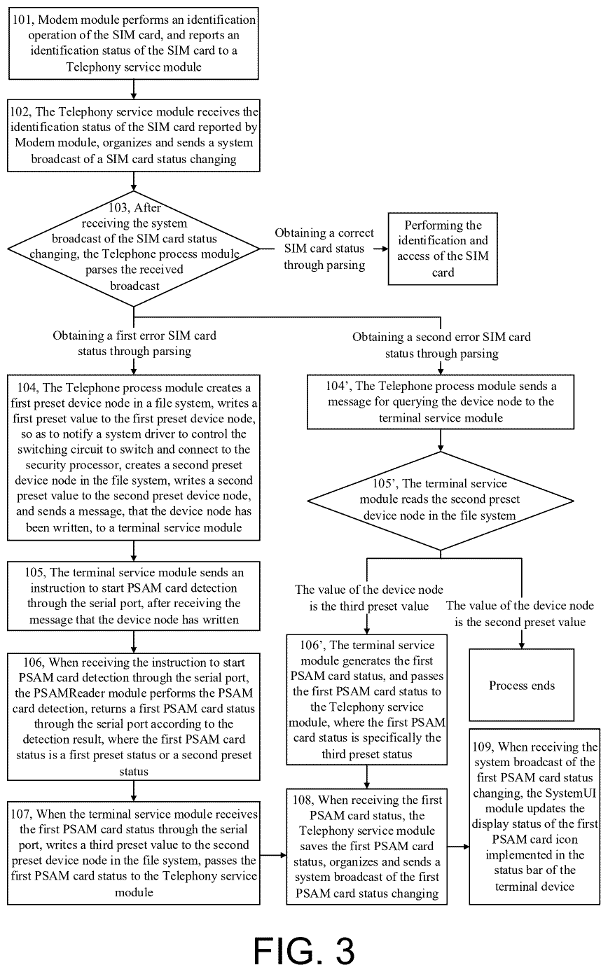

When the terminal device is started, or if a card is inserted or removed in the common card slot for the PSAM card and the SIM card after the terminal device is started, performing the following steps as shown in FIG. 3:

Step 101, a Modem module performs an identification operation of the SIM card, and reports an identification status of the SIM card to a Telephony service module.

It should be noted that the identification operation of the SIM card is the prior art, and the application is not specifically limited.

Step 102, the Telephony service module receives the identification status of the SIM card reported by Modem module, organizes and sends a system broadcast of a SIM card status changing;

Step 103, after receiving the system broadcast of the SIM card status changing, the Telephone process module parses the received broadcast, if obtaining a correct SIM card status through parsing, then performs the identification and access of the SIM card, if obtaining a first error SIM card status through parsing, then performs the Step 104, and if obtaining a second error SIM card status through parsing, then performs the step 104′.

It should be noted that the identification and access of the SIM card are prior art, and the application is not specifically limited.

In one possible embodiment, the first error SIM card status is specifically IO_ERROR, and the second error SIM card status is ABSENT.

Step 104, the Telephone process module creates a first preset device node in a file system, writes a first preset value to the first preset device node, so as to notify a system driver to control the switching circuit to switch and connect to the security processor, creates a second preset device node in the file system, writes a second preset value to the second preset device node, and sends a message, that the device node has been written, to a terminal service module;
the Telephone process module sends a message, that has been written by the device node, to the terminal service module, which can be specifically: the Telephone process module sends a message of type Message to the terminal service module by calling a receiving external message interface of the terminal service module; For example, the terminal service module encapsulates an SDK externally, and the Telephone process module introduces a jar package of the SDK, which includes an interface handlePSAMMessage() to receive an external message, the Telephone process module calls the handlePSAMMessage(), and the interface passes in a message with a parameter of Message. When the handlePSAMMessage() is called, the Terminal Services module receives the message and performs the corresponding message processing.

In one possible embodiment, a first preset device node/dev/psam/psam_status is created in the file system and the first preset value 0×01 is written; a second preset device node/dev/psam/psam_slot is created in the file system, and the second preset value 0×00 is written.

Step 105, the terminal service module sends an instruction to start PSAM card detection through the serial port, after receiving the message that the device node has written.

In this embodiment, the terminal service module sends an instruction to start PSAM card detection through the serial port, specifically: the terminal service module sends an APDU instruction to start PSAM card detection through the serial port.

Step 106, when receiving the instruction to start PSAM card detection through the serial port, the PSAMReader module performs the PSAM card detection, returns a first PSAM card status through the serial port according to the detection result, where the first PSAM card status is a first preset status or a second preset status.

In this embodiment, the PSAMReader module performs the PSAM card detection, and returns the first PSAM card status through the serial port according to the detection result, specifically: the PSAMReader module initiates the PSAM card detection, reads the information of the card in the common card slot for the PSAM card and the SIM card, and returns the first preset status through the serial port if the PSAMReader module successfully reads the information of the card in the common card slot for the PSAM card and the SIM card; if the PSAMReader module fails to read the information of the card in the common card slot for the PSAM card and the SIM card, it returns the second preset status through the serial port.

In one possible embodiment, the first preset status is specifically READY, and the second preset status is specifically ERROR.

Step 107, when the terminal service module receives the first PSAM card status through the serial port, writes a third preset value to the second preset device node in the file system, passes the first PSAM card status to the Telephony service module, and executes Step 108.

In a possible embodiment, the terminal service module passes the first PSAM card status to the Telephony service module through the TelephonyManager-like update PSAM card status interface updataPSAMSStatus() of the external interface provided by the Telephony service module.

The third preset value is, for example, 0×01.

Step 104′, the Telephone process module sends a message for querying the device node to the terminal service module;

Step 105′, the terminal service module reads the second preset device node in the file system, if the value of the device node is the third preset value, then step 106′ is executed, and if the value of the device node is the second preset value, the process ends;

Step 106′, the terminal service module generates the first PSAM card status, and passes the first PSAM card status to the Telephony service module, where the first PSAM card status is specifically the third preset status, and the step 108 is executed.

In one possible embodiment, the third preset status is specifically ABSENT.

Step 108, when receiving the first PSAM card status, the Telephony service module saves the first PSAM card status, organizes and sends a system broadcast of the first PSAM card status changing.

In a possible embodiment, when the Telephony Manager-like update PSAM card status interface updatePSAMStatus() of the external interface provided by the Telephony service module is called, the Telephony service module obtains the first PSAM card status passed in as a parameter, and saves the first PSAM card status to the first preset member variable PSAMStatus1.

In this embodiment, the first PSAM card status is carried in the system broadcast of the first PSAM card status changing.

In one possible embodiment, organizing and sending the system broadcast of the first PSAM card status changing includes: creating an Intent, specifying the action of the Intent as android.intent.action.PSAM_STATE_CHANGED, encapsulating a data structure Bundle, and storing data in the form of key-value to the Bundle through a mode of put, wherein the key can be specifically ps, value is the first PSAM card status.

Optionally, after the Telephony service module organizes the system broadcast of the first PSAM card status changing, it further includes that defining the broadcast as a protected broadcast, and a corresponding permission is required to receive the broadcast.

Step 109, when receiving the system broadcast of the first PSAM card status changing, the SystemUI module updates the display status of the first PSAM card icon implemented in the status bar of the terminal device.

In this embodiment, when initialized, the SystemUI module registers and listens to the system broadcast of the first PSAM card status changing, and the registration type is resident; after the Telephony service module sends the system broadcast of the first PSAM card status changing, the preset broadcast receiving method of the SystemUI module is called, the SystemUI module receives the system broadcast of the first PSAM card status changing, and obtains the first PSAM card status carried by the broadcast.

In one possible embodiment, when the SystemUI module is initialized, the Intent with an action of android. intent. action. PSAM_STATE_CHANGED is registered and listened, after the Telephony service module sends the system broadcast of the first PSAM card status changing, a broadcast receiving method onReceive() of an implementation class PSAMStatusControllerImpl of a preset custom interface class PSAMStatusController of the SystemUI module is automatically called back, when onReceive() is called, the incoming parameter Intent is obtained, and the action of the Intent is android.intent.action.PSAM_STATE_ CHANGED, the system method intent.getStringExtra(“ps”) is called to get the first PSAM card status of the String type.

In one possible embodiment, the SystemUI module presets a custom interface class PSAMStatusController, which is an interface class that controls the status of PSAM, and the implementation class PSAMStatusControllerImpl of the PSAMStatusController inherits from broadcast, the first member variable of the interface class, the first PSAM status view, PSAMStatusView1, includes the first icon status IconState1 of the inner class, and IconState1 includes the attributes visible and icon, which control whether to display the first PSAM card icon and the style of the first PSAM card icon, respectively. PSAMStatusView1 also includes an update icon method, updateIcon(), and the SystemUI module updates the visible and icon properties of IconState1 by calling updateIcon().

Further, when updateIcon() is called:
if the first PSAM card status is the first preset status, the visible attribute of IconState 1 is updated to true, and the icon attribute of IconState1 is updated to a pattern image of READY;
if the first PSAM card status is the second preset status, the visible attribute of IconState1 is updated to true, and the icon attribute of IconState1 is updated to a pattern image of ERROR;
if the first PSAM card status is the third default status, the visible attribute of IconState1 is updated to false, and the icon attribute of IconState1 is updated to NULL.

Optionally, Step 109 further includes: when receiving the broadcast of the first PSAM card status changing, the system Settings module updates the status of the PSAM card switch menu.

In a possible embodiment, when starting to display the PSAM card switch menu, the system Settings module registers and listens to the system broadcast of the first PSAM card status changing, after the Telephony service module sends the system broadcast of the first PSAM card status changing, the preset broadcast receiving method of the system Settings module is called, the system Settings module receives the system broadcast of the first PSAM card status changing, obtains the first PSAM card status that the broadcast carries, and when the display of the PSAM card switch menu is closed, the system Settings module cancels listening to the system broadcast of the first PSAM card status changing.

In one possible embodiment, after the Telephony service module sends the system broadcast of the first PSAM card status changing, if the PSAM card switch menu is in the display status, the broadcast reception method onReceive() of the inner class MyBroadCast of the preset custom class PSAMStatusPreference of the system Settings module is automatically called back; Specifically, the preset custom class PSAMStatusPreference of the system Settings module is used to implement the PSAM card switch menu, which inherits from the system switch menu SwitchPreference, and the inner class MyBroadCast of PSAMStatusPreference also includes the update menu method updatePreference(), the system Settings module updates the status of the PSAM card switch menu by calling updatePreference().

Further, when updatePreference() is called:
if the first PSAM card status is the first preset status or the second preset status, the update PSAM card switch menu is open.
if the first PSAM card status is the third preset status, the update PSAM card switch menu is not clickable.

Specifically, the Modem module, the Telephony service module, the phone process module, the terminal service module, the status bar (SystemUI) module and the system Settings module are arranged on the application processor of the terminal device, and the PSAM read (PSAMReader) module is arranged on the security processor of the terminal device. The Modem module is an existing module, the Telephony service module, the Phone process module, the SystemUI module and the Settings module are improved based on the existing module, and the terminal service module and the PSAMReader module are self-implemented modules.

Further, the method provided in this embodiment further includes that when starting to display the PSAM card switch menu, the Settings module also obtains the first PSAM card status saved by the Telephony service module from the Telephony service module, and determines the status of the PSAM card switch menu.

In one possible embodiment, the terminal service module obtains the first PSAM card status saved by the Telephony service module through the Telephony Manager-like get PSAM card status interface getPSAMStatus() of the external interface provided by the Telephony service module.

Specifically, if the first PSAM card status obtained is the first preset status, the second preset status, or the fourth preset status, the status of the PSAM card switch menu is set to Open, if the first PSAM card status obtained is the third preset status, the status of the PSAM card switch menu is set to Unclickable, and if the first PSAM card status obtained is the fifth preset status, the status of the PSAM card switch menu is determined to be off.

Correspondingly, the PSAM card automatic identification and display method provided in this embodiment may also comprise:

Step 201, when it is detected that there is a card removal from the common card slot for the SAM card and the SIM card, the PSAMReader module sends the first PSAM card status through the serial port, and the first PSAM card status is specifically the third preset status;

Step 202, when receiving the first PSAM card status through the serial port, the terminal service module passes the first PSAM card status to the Telephony service module;

Step 203, when receiving the first PSAM card status, the Telephony service module saves the first PSAM card status, organizes and sends the system broadcast of the first PSAM card status changing, and writes the fourth preset value to the first preset device node created in the file system to notify the system driver to control the switching circuit to switch and connect to the application processor.

In one possible embodiment, the fourth preset value is 0×00.

Step 204, when receiving a system broadcast of the first PSAM card status changing, the SystemUI module updates the display status of the first PSAM card icon implemented in the status bar of the terminal device.

In this embodiment, when the SystemUI module is initialized, it registers and listens to the system broadcast of the first PSAM card status changing, and after the Telephony service module sends the system broadcast of the first PSAM card status changing, the preset broadcast receiving method of the SystemUI module is called, and the SystemUI module receives the system broadcast of the first PSAM card status changing, and obtains the first PSAM card status carried by the broadcast.

In one possible embodiment, when initialized, the SystemUI module registers and listens to an Intent with an action of android.intent.action.PSAM_STATE_CHANGED, where a registration type is resident. After the Telephony service module sends the system broadcast of the first PSAM card status changing, the broadcast receiving method onReceive() of the implementation class PSAMStatusControllerImpl of the preset custom interface class PSAMStatusController of the SystemUI module is automatically called back, and when onReceive() is called, the incoming parameter Intent is obtained, the action of the Intent is android.intent.action.PSAM_STATE_CHANGED, and the system method intent.getStringExtra(“ps”) is called to get the first PSAM card status of the String type.

In one possible embodiment, the SystemUI module presets a custom interface class PSAMStatusController, which is an interface class that controls the status of PSAM, and the implementation class PSAMStatusControllerImpl of the PSAMStatusController inherits from the broadcast, the first member variable of the interface class, the first PSAM status view, PSAMStatus View1, includes the first icon status IconState1 of the inner class, and IconState1 includes the attributes visible and icon, which control whether to display the first PSAM card icon and the style of the first PSAM card icon, respectively. PSAMStatus View1 also includes an update icon method, updateIcon(), and the SystemUI module updates the visible and icon properties of IconState1 by calling updateIcon().

Further, when updateIcon() is called:
if the first PSAM card status is the third default status, the visible attribute of IconState1 is updated to false, and the icon attribute of IconState1 is updated to NULL.

Optionally, step 204 further includes: when receiving the broadcast of the first PSAM card status changing, the Settings module updates the status of the PSAM card switch menu.

In a possible embodiment, when starting to display the PSAM card switch menu, the Settings module registers and listens to the system broadcast of the first PSAM card status changing, after the Telephony service module sends the system broadcast of the first PSAM card status changing, the preset broadcast receiving method of the Settings module is called, the Settings module receives the system broadcast of the first PSAM card status changing, obtains the first PSAM card status that the broadcast carries, and when the display of the PSAM card switch menu is closed, the Settings module cancels listening to the system broadcast of the first PSAM card status changing.

In one possible embodiment, after the Telephony service module sends a system broadcast of the first PSAM card status changing, if the PSAM card switch menu is in the display status, the broadcast receiving method onReceive() of the inner class MyBroadCast of the preset custom class PSAMStatusPreference of the Settings module is automatically called back; Specifically, the preset custom class PSAMStatusPreference of the Settings module is used to implement the PSAM card switch menu, which inherits from the system switch menu SwitchPreference, and the inner class MyBroadCast of PSAMStatusPreference also includes the update menu method updatePreference(), the Settings module updates the status of the PSAM card switch menu by calling updatePreference().

Further, when updatePreference() is called:
if the first PSAM card status is the third preset status, the update PSAM card switch menu is not clickable.

The automatic identification and display method of the PSAM card provided in this embodiment may also include: when the user disables the PSAM card on the PSAM card switch of the PSAM card switch menu page, performing the following steps:

Step 301, the Settings module sends a PSAM card disable notification to the Telephony service module.

In one possible embodiment, step 301 specifically comprises that the Settings module calls Telephony Manager-like disable PSAM card interface disablePSAMCard() of the external interface provided by the Telephony service module.

Step 302, the Telephony service module receives the PSAM card disable notification, updates the saved first PSAM card status to the fourth preset status, organizes and sends a system broadcast of the first PSAM card status changing, and writes the fourth preset value to the first preset device node created in the file system to notify the system driver to control the switching circuit to switch and connect to the application processor.

In one possible embodiment, Step 302 specifically includes that when the Telephony Manager-like disable PSAM card interface disablePSAMCard() of the external interface provided by the Telephony service module is called, updating the value of the first preset member variable PSAMStatus1 to the fourth preset status; where the fourth preset status is DISABLE, for example.

Step 303, when receiving the system broadcast of the first PSAM card status changing:
the SystemUI module updates the display status of the first PSAM card icon implemented in the status bar of the terminal device;
the Settings module updates the status of the PSAM card switch menu on the PSAM card switch menu page.

In this embodiment, when the SystemUI module is initialized, it registers and listens to the system broadcast of the first PSAM card status changing, and after the Telephony service module sends the system broadcast of the first PSAM card status changing, the preset broadcast receiving method of the SystemUI module is called, and the SystemUI module receives the system broadcast of the first PSAM card status changing, and obtains the first PSAM card status carried by the broadcast.

In one possible embodiment, the SystemUI module registers and listens to an Intent with an action of android. intent. action. PSAM_STATE_CHANGED when initialized, where a registration type is resident. When the Telephony service module sends the system broadcast of the first PSAM card status changing, the broadcast receiving method onReceive() of the implementation class PSAMStatusControllerImpl of the preset custom interface class PSAMStatusController of the SystemUI module is automatically called back, and when onReceive() is called, the incoming parameter Intent is obtained, the action of the Intent is android. intent. action. PSAM STATE_CHANGED, and the system method intent.getStringExtra(“ps”) is called to get the first PSAM card status of the String type.

In one possible embodiment, the SystemUI module presets a custom interface class PSAMStatusController, which is an interface class that controls the status of PSAM, and the implementation class PSAMStatusControllerImpl of the PSAMStatusController inherits from the broadcast, the first member variable of the interface class, the first PSAM status view, PSAMStatus View1, includes the first icon status of the inner class IconState1, and IconState1 includes the attributes visible and icon, which control whether to display the first PSAM card icon and the style of the first PSAM card icon, respectively. PSAMStatusView1 also includes an update icon method, updateIcon(), and the SystemUI module updates the visible and icon properties of IconState1 by calling updateIcon().

Further, when updateIcon() is called:
if the first PSAM card status is the fourth preset status, the visible attribute of IconState1 is updated to true, and the icon attribute of IconState1 is updated to a pattern image of DISABLE.

In one possible embodiment, when starting to display the PSAM card switch menu, the Settings module registers and listens to the system broadcast of the first PSAM card status changing, after the Telephony service module sends the system broadcast of the first PSAM card status changing, the preset broadcast receiving method of the Settings module is called, the Settings module receives the system broadcast of the first PSAM card status changing, obtains the first PSAM card status carried by the broadcast, and when the display of the PSAM card switch menu is turned off, the Settings module cancels listening to the system broadcast of the first PSAM card status changing.

In one possible embodiment, after the Telephony service module sends a system broadcast of the first PSAM card status changing, if the PSAM card switch menu is in the display status, the broadcast receiving method onReceive() of the inner class MyBroadCast of the preset custom class PSAMStatusPreference of the Settings module is automatically called back; Specifically, the preset custom class PSAMStatusPreference of the Settings module is used to implement the PSAM card switch menu, which inherits from the system switch menu SwitchPreference, and the inner class MyBroadCast of PSAMStatusPreference also includes the update menu method updatePreference(), the Settings module updates the status of the PSAM card switch menu by calling updatePreference().

Further, when updatePreference() is called:
if the first PSAM card status is the fourth preset status, the update PSAM card switch menu is off.

The automatic identification and display method of the PSAM card provided in the present embodiment may also include: when the user operates the PSAM card switch of the PSAM card switch menu page to enable the PSAM card, performing the following steps:

Step 401, the Settings module sends a PSAM card enable notification to the Telephony service module.

In one possible embodiment, step 401 specifically comprises that the Settings module calls Telephony Manager-like enable PSAM card interface enablePSAMCard() of the external interface provided by the Telephony service module.

Step 402, the Telephony service module receives the PSAM card enable notification, updates the saved first PSAM card status to the fifth preset status, organizes and sends a system broadcast of the first PSAM card status changing, and writes the first preset value to the first preset device node created in the file system to notify the system driver to control the switching circuit to connect to the security processor.

In one possible embodiment, step 402 specifically includes that when the Telephony Manager-like enable PSAM card interface enablePSAMCard() of the external interface provided by the Telephony service module is called, the value of the first preset member variable PSAMStatus1 is updated to the fifth preset status; where the fifth preset status is, for example, ENABLE.

Step 403 when receiving the system broadcast of the first PSAM card status changing:
the SystemUI module updates the display status of the first PSAM card icon implemented in the status bar of the terminal device;
the Settings module updates the status of the PSAM card switch menu on the PSAM card switch menu page.

In this embodiment, when the SystemUI module is initialized, it registers and listens to the system broadcast of the first PSAM card status changing, and after the Telephony service module sends the system broadcast of the first PSAM card status changing, the preset broadcast receiving method of the SystemUI module is called, and the SystemUI module receives the system broadcast of the first PSAM card status changing, and obtains the first PSAM card status carried by the broadcast.

In one possible embodiment, the SystemUI module registers and listens to an Intent with an action of android.intent.action.PSAM_STATE_CHANGED when initialized, where a registration type is resident. When the Telephony service module sends the system broadcast of the first PSAM card status changing, the broadcast receiving method onReceive() of the implementation class PSAMStatusControllerImpl of the preset custom interface class PSAMStatusController of the SystemUI module is automatically called back, and when onReceive() is called, the incoming parameter Intent is obtained, the action of the Intent is android.intent.action.PSAM_STATE_CHANGED, and the system method intent.getStringExtra(“ps”) is called to get the first PSAM card status of the String type.

In one possible embodiment, the SystemUI module presets a custom interface class PSAMStatusController, which is an interface class that controls the status of PSAM, and the implementation class PSAMStatusControllerImpl of the PSAMStatusController inherits from the broadcast, the first member variable of the interface class, the first PSAM status view, PSAMStatusView1, includes the first icon status of the inner class IconState1, and IconState1 includes the attributes visible and icon, which control whether to display the first PSAM card icon and the style of the first PSAM card icon, respectively. PSAMStatusView1 also includes an update icon method, updateIcon(), and the SystemUI module updates the visible and icon properties of IconState1 by calling updateIcon().

Further, when updateIcon() is called:
if the first PSAM card status is the fifth default status, the visible attribute of IconState 1 is updated to true, and the icon attribute of IconState1 is updated to a pattern image of ENABLE.

In one possible embodiment, when starting to display the PSAM card switch menu, the Settings module registers and listens to the system broadcast of the first PSAM card status changing, after the Telephony service module sends the system broadcast of the first PSAM card status changing, the preset broadcast receiving method of the Settings module is called, the Settings module receives the system broadcast of the first PSAM card status changing, obtains the first PSAM card status carried by the broadcast, and when the display of the PSAM card switch menu is turned off, the Settings module cancels listening to the system broadcast of the first PSAM card status changing.

In one possible embodiment, after the Telephony service module sends a system broadcast of the first PSAM card status changing, if the PSAM card switch menu is in the display status, the broadcast receiving method onReceive() of the inner class MyBroadCast of the preset custom class PSAMStatusPreference of the Settings module is automatically called back; Specifically, the preset custom class PSAMStatusPreference of the Settings module is used to implement the PSAM card switch menu, which inherits from the system switch menu SwitchPreference, and the inner class MyBroadCast of PSAMStatusPreference also includes the update menu method updatePreference(), the Settings module updates the status of the PSAM card switch menu by calling updatePreference().

Further, when updatePreference() is called:
if the first PSAM card status is the fifth default status, the update PSAM card switch menu is turned on.

In this embodiment, as shown in FIG. 2, the aforesaid terminal device may also be provided with at least one PSAM card-specific card slot, the PSAM-specific card slot communicates with the security processor through a 7816 interface, and the PSAM card automatic identification and display method provided in this embodiment may also include, when there is a card inserted or removed in the PSAM card-specific card slot, the following steps are performed:

Step 501, the PSAMReader module performs PSAM card detection, sends the second PSAM card status through the serial port according to the detection result, and the second PSAM card status is the first preset status or the second preset status or the third preset status.

In this embodiment, the PSAMReader module performs PSAM card detection, and according to the detection result, the second PSAM card status can be returned through the serial port as follows: the PSAMReader module initiates PSAM card detection, reads the information of the card in the PSAMspecific card slot, and if the PSAM card reading module successfully reads the information of the card in the PSAM special card slot, the first preset status is sent through the serial port; if the PSAM card reading module fails to read the information of the card in the PSAM-specific card slot, the second preset status is sent through the serial port; if the PSAM card reading module does not detect the card, the third preset status is sent through the serial port.

In one possible embodiment, the first preset status is READY, the second preset status is ERROR, and the third preset status is ABSENT.

Step 502, when receiving the second PSAM card status through the serial port, the terminal service module passes the second PSAM card status to the Telephony service module.

In one possible embodiment, the terminal service module passes the second PSAM card status to the Telephony service module through the Telephony Manager-like update PSAM card status interface updatePSAMStatus() of the external interface provided by the Telephony service module.

Step 503, when receiving the second PSAM card status, the Telephony service module saves the second PSAM card status, organizes and sends the system broadcast of the second PSAM card status changing.

In one possible embodiment, when the TelephonyManager-like update PSAM card status interface updatePSAMStatus() of the external interface provided by the Telephony service module is called, the Telephony service module obtains the second PSAM card status passed in as a parameter, and saves the second PSAM card status to the second preset member variable PSAMStatus2.

In this embodiment, the system broadcast of the second PSAM card status changing carries the second PSAM card status.

Optionally, after the Telephony service module organizes the system broadcast of a second PSAM card status changing, it also includes defining the broadcast as a protected broadcast and receiving the broadcast requires a corresponding permission.

Step 504, when receiving the system broadcast of the second PSAM card status changing, the SystemUI module updates the display status of the second PSAM card icon implemented in the status bar of the terminal device.

In this embodiment, when initialized, the SystemUI module registers and listens to the system broadcast of the second PSAM card status changing, the registration type is resident, after the Telephony service module sends the system broadcast of the second PSAM card status changing, the preset broadcast receiving method of the SystemUI module is called, the SystemUI module receives the system broadcast of the second PSAM card status changing, and obtains the second PSAM card status carried by the broadcast.

In one possible embodiment, when the Telephony service module sends the system broadcast of the second PSAM card status changing, the broadcast receiving method onReceive() of the implementation class PSAMStatusControllerImpl of the preset custom interface class PSAMStatusController of the SystemUI module is automatically called back.

Specifically, the preset custom interface class PSAMStatusController of the SystemUI module is an interface class that controls the status of PSAM, and the implementation class PSAMStatusControllerImpl of the PSAMStatusController inherits from the broadcast. The second member variable of the interface class, the second PSAM status view, PSAMStatus View2, includes the second icon status IconState2 of the inner class, and IconState2 includes the attributes visible and icon, which control whether to display the second PSAM card icon and the style of the second PSAM card icon, respectively. PSAMStatusView2 also includes an update icon method, updateIcon(), and the SystemUI module updates the visible and icon properties of IconState2 by calling updateIcon().

Further, when updateIcon() of PSAMStatus View2 is called:
if the second PSAM card status is the first preset status, the visible attribute of IconState2 is updated to true, and the icon attribute of IconState2 is updated to the pattern image of READY;
if the second PSAM card status is the second default status, the visible attribute of IconState2 is updated to true, and the icon attribute of IconState2 is updated to the pattern image of ERROR;
if the second SAM card is in the third default status, the visible attribute of IconState2 is updated to false, and the icon attribute of IconState2 is updated to NULL.

### THIRD EMBODIMENT

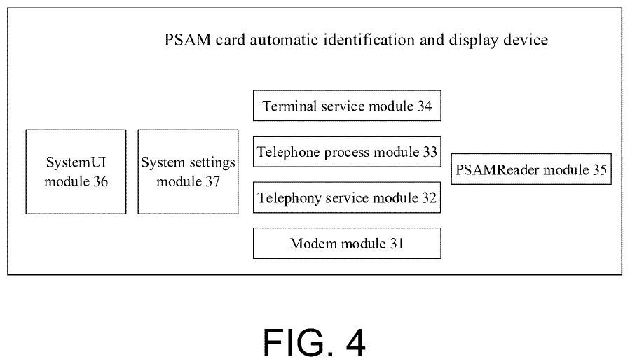

This embodiment provides a PSAM card automatic identification and display device, which is applied to a terminal device that is provided with an application processor and a security processor, and the terminal device includes at least one common card slot for a PSAM card and a SIM card, with reference to FIG. 4, and the device includes:
a Modem module 31, configured to perform an identification operation of the SIM card, and report an identification status of the SIM card to a Telephony service module 32;
the Telephony service module 32, configured to receive the identification status of the SIM card reported by the Modem module 31, and organize and send a system broadcast of a SIM card status changing;
a Telephone process module 33, configured to parse the system broadcast of the SIM card status changing after receiving the system broadcast of the SIM card status changing, create a first preset device node in a file system when obtaining a first error SIM card status through parsing, write a first preset value to the first preset device node, so as to notify a system driver to control the switching circuit of the common card slot to switch and connect to the security processor, and send a message, that the device node has been written, to a terminal service module 34;
the terminal service module 34, configured to send an instruction to start a PSAM card detection through a serial port after receiving the message that the device node has written;
a PSAMReader module 35, configured to perform the PSAM card detection when receiving the instruction to start PSAM card detection through the serial port, and return a first PSAM card status through the serial port according to a detection result;
the terminal service module 34 is further configured to pass the first PSAM card status to the Telephony service module 32 when receiving the first PSAM card status through the serial port;
the Telephony service module 32 is also configured to organize and send the system broadcast of the first PSAM card status changing after receiving the first PSAM card status.

The device further includes a SystemUI module 36 configured to update a display status of a first PSAM card icon in a status bar of the terminal device when receiving the system broadcast of the first PSAM card status changing;
the Modem module 31, the Telephony service module 32, the Telephone process module 33, the terminal service module 34, the SystemUI module 36 are arranged on the application processor of the terminal device, and the PSAMReader module 35 is arranged on the security processor of the terminal device; when the terminal device is powered on, the switching circuit of the common card slot for the PSAM card and the SIM card is connected to the application processor of the terminal device by default.

In one possible embodiment, the Telephone process module 33 is further configured to create a second preset device node in the file system when obtaining the first error SIM card status through parsing, and write a second preset value to the second preset device node; the terminal service module 34 is further configured to write a third preset value to the second preset device node when receiving the first PSAM card status; the Telephone process module 33 is further configured to, when parsing the system broadcast of the SIM card status changing to obtain a second error SIM card status, send a message for querying the device node to the terminal service module 34; the terminal service module 34 is further configured to read the second preset device node in the file system when receiving the message for querying the device node, if the value of the second preset device node is the third preset value, then generate the first PSAM card status, and pass the first PSAM card status to the Telephony service module 32, and if the value of the second preset device node is the second preset value, perform the identification and access of SIM card.

In a possible embodiment, the PSAMReader module 35 is further configured to send the first PSAM card status, specifically being the third preset status, through the serial port when detecting that the PSAM card is removed from the common card slot for the PSAM card and the SIM card; the Telephony service module 32 is further configured to, when receiving the first PSAM card status that is specifically the third preset status, write the second preset value to the first preset device node in the file system, so as to notify the system driver to control the switching circuit of the common card slot for the PSAM card and the SIM card to switch and connect to the application processor.

In one possible embodiment, the Telephone process module 33 is further configured to perform the identification and access of the SIM card when parsing the system broadcast of the SIM card status changing to obtain the correct SIM card status.

Optionally, when initialized, the SystemUI module 36 registers and listens to the system broadcast of the first PSAM card status changing; when the Telephony service module 32 sends the system broadcast of the first PSAM card status changing, the broadcast receiving method in the implementation of the preset custom interface class of the SystemUI module 36 is automatically called back.

In a possible embodiment, the apparatus further includes a system Settings module 37, configured to update the status of the PSAM card switch menu when receiving the system broadcast of the first PSAM card status changing.

Further, the Telephony service module 32 is further configured to save the received first PSAM card status after receiving the first PSAM card status; when initialized, the system Settings module 37 obtains the first PSAM card status saved by the Telephony service module 32 from the Telephony service module 32, and determines the status of the PSAM card switch menu according to the obtained first PSAM card status.

In a possible embodiment, the system Settings module 37 is further configured to send a PSAM card disable notification to the Telephony service module 32; the Telephony service module 32 is further configured to update the saved first PSAM card status to the fourth preset status after receiving the PSAM card disable notification, organize and send the system broadcast of the first PSAM card status changing, and write the second preset value to the first preset device node in the file system to notify the system driver to control the switching circuit of the common card slot for the PSAM card and the SIM card to switch and connect to the application processor.

In one possible embodiment, the system Settings module 37 is further configured to send a PSAM card enable notification to the Telephony service module 32; the Telephony service module 32 is further configured to update the saved first PSAM card status to the fifth preset status after receiving the PSAM card enable notification, organize and send the system broadcast of the first PSAM card status changing, and write the first preset value to the first preset device node in the file system to notify the system driver to control the switching circuit of the common card slot for the PSAM card and the SIM card to switch and connect to the security processor.

Optionally, when starting to display the PSAM card switch menu, the system Settings module 37 registers and listens to the system broadcast of the first PSAM card status changing, when the Telephony service module 32 sends the system broadcast of the first PSAM card status changing, the preset broadcast receiving method of the system Settings module 37 is called, the system Settings module 37 receives the system broadcast of the first PSAM card status changing, obtains the first PSAM card status in this broadcast; when the display of the PSAM card switch menu is turned off, the system Settings module 37 cancels listening to the system broadcast of the first PSAM card status changing.

In one possible embodiment, the terminal device further includes at least one PSAM card-specific card slot; the PSAMReader module 35 is further configured to, when there is a card inserted or removed in the PSAM card-specific card slot, perform the PSAM card detection, and send the second PSAM card status through the serial port according to the detection result; the terminal service module 34 is further configured to pass the second PSAM card status to the Telephony service module 32 when receiving the second PSAM card status through the serial port; the Telephony service module 32 is further configured to organize and send the system broadcast of the second PSAM card status changing after receiving the second PSAM card status; the SystemUI module 36 is further configured to update a display status of a second PSAM card icon in the status bar of the terminal device when receiving the system broadcast of the second PSAM card status changing.

The specific limitation of the technical features involved in this embodiment can refer to the record in the embodiments describing the method, and will not be repeated here.

A person skilled in the art may understand that the modules of the device disclosed in the present application may be integrated or deployed separately. The above modules can be combined into a single module or further split into multiple submodules.

A person skilled in the art may understand that the drawings are only schematic diagrams of preferred embodiments, and that the modules or processes in the drawings are not necessary for the implementation of the present application.

Those skilled in the art may understand that the modules in the apparatus in the embodiments may be distributed in the apparatus of the embodiments according to the description of the embodiments, or may be changed accordingly and located in one or more apparatus different from the embodiments. The modules of the above embodiment may be combined into a module, or may be further split into a plurality of submodules.

Optionally, the application also provides an electronic device including a processor, a memory and instructions stored on the memory and executable by the processor, and the processor executes the instructions to achieve the method described in the embodiments of the present application. Of course, the memory can also be left out of the device. The device may be a stand-alone device or a chip, a chip system, or processor, etc., that supports the device to implement the above methods. When the device is a chip system, it may be composed of a chip or may also contain the chip and other discrete devices, and the embodiment of the present application does not specifically limit this; the chip is coupled with the memory and is used to execute a computer program stored in the memory to perform the method described in the above embodiment.

In the above embodiment, it may be realized in whole or in part by software, hardware, firmware, or any combination thereof. When implemented using a software program, it can be implemented in whole or in part in the form of a computer program product. The computer program product includes one or more computer programs. When a computer program is loaded and executed, a process or function described in the embodiments of the present application is generated, in whole or in part. The computer program can be stored in one computer-readable storage medium, or transferred from one computer-readable storage medium to another. For example, the computer instruction may be transmitted from a base station, a registered device, a server, or a data center to another base station, a registered device, a server, or a data center by wired (e.g., coaxial cable, optical fiber, digital subscriber line, DSL)) or wireless (e.g., infrared, wireless, microwave, etc.). The computer-readable storage medium may be any usable medium that the registration device can access or comprise one or more data storage devices such as servers, data centers, etc., that can be integrated with the medium. The available medium may be magnetic media (e.g., floppy disk, hard disk, magnetic tape), optical medium (e.g., Digital Video Disc, DVD), or semiconductor medium (e.g., solid status disk (SSD)).

The serial numbers of the present application are for description only and do not represent the advantages and disadvantages of the embodiments.

Although the present application is described in conjunction with the specific features and its embodiments, it is obvious that it can be modified and combined in various ways without departing from the spirit and scope of the present application. Accordingly, this description and drawings are only illustrative of the present application as defined by the attached claims and are deemed to have covered any and all modifications, variations, combinations or equivalents within the scope of the present application. Obviously, a person skilled in the art may make various alterations and variations to the application without departing from the spirit and scope of the application. Thus, if these modifications and variants of the present application fall within the scope of the claims of the present application and their equivalents, the present application is also intended to include such modifications and variants.

What is claimed is:

1. A purchase secure access module PSAM card automatic identification and display method, wherein applied to a terminal device equipped with an application processor and a security processor, wherein the terminal device comprises at least one common card slot for a PSAM card and a subscriber identity module SIM card, the method comprises:
Step A0, performing, by a Modem module, an identification operation of the SIM card, and reporting an identification status of the SIM card to a Telephony service module;
Step A1, receiving, by the Telephony service module, the identification status of the SIM card reported by the Modem module, and organizing and sending a system broadcast of a SIM card status changing;
Step A2, parsing, by a Telephone process module, the system broadcast of the SIM card status changing, after receiving the system broadcast of the SIM card status changing, creating a first preset device node in a file system when obtaining a first error SIM card status through parsing, writing a first preset value to the first preset device node, so as to notify a system driver to control a switching circuit of the common card slot to switch and connect to the security processor, and sending a message, that the first preset value has been written into the first preset device node, to a terminal service module;
Step A3, sending, by the terminal service module, an instruction to start a PSAM card detection through a serial port, after receiving the message that the first preset value has been written into the first preset device node;
Step A4, performing, by a PSAMReader module, the PSAM card detection, when receiving the instruction to start the PSAM card detection through the serial port, and returning a first PSAM card status through the serial port according to a detection result;
Step A5, passing, by the terminal service module, the first PSAM card status to the Telephony service module, when receiving the first PSAM card status through the serial port;
Step A6, organizing and sending, by the Telephony service module, the system broadcast of the first PSAM card status changing, after receiving the first PSAM card status; and
Step A7, updating, by a SystemUI module, a display status of a first PSAM card icon in a status bar of the terminal device, when receiving the system broadcast of the first PSAM card status changing;
wherein the Modem module, the Telephony service module, the Telephone process module, the terminal service module and the SystemUI module are arranged on the application processor, the PSAMReader module is arranged on the security processor;
when the terminal device is powered on, the switching circuit of the common card slot is connected to the application processor by default.

2. The method according to claim 1, wherein in the Step A2, when obtaining the first error SIM card status through parsing, it further comprises creating a second preset device node in the file system, and writing a second preset value to the second preset device node;
in the Step A5, it further comprises: writing a third preset value to the second preset device node when the terminal service module receives the first PSAM card status through the serial port; and
in the Step A2, it further comprises: sending, by the Telephone process module, a message for querying the device node to the terminal service module when obtaining a second error SIM card status through parsing; reading, by the terminal service module, the second preset device node when receiving the message of querying the device node, if the value of the second preset device node is the third preset value, then generating the first PSAM card status, passing the first PSAM card status to the Telephony service module, and executing the Step A6, and if the value of the second preset device node is the second preset value, then performing identification and access of the SIM card.

3. The method according to claim 1, wherein in the Step A4, the performing the PSAM card detection, and returning the first PSAM card status through the serial port according to the detection result comprises: starting the PSAM card detection, reading information of a card in the common card slot, if the information of the card in the common card slot is read successfully, then returning a first preset status through the serial port, and if the information of the card in the common card slot fails to read, then returning a second preset status through the serial port.

4. The method according to claim 1, wherein further comprising:
Step B1, sending, by the PSAMReader module, the first PSAM card status through the serial port, when the PSAM card is detected to be removed from the common card slot, wherein the first PSAM card status is specifically a third preset status;
Step B2, passing, by the terminal service module, the first PSAM card status to the Telephony service module when receiving the first PSAM card status through the serial port;
Step B3, organizing and sending, by the Telephony service module, when receiving the first PSAM card status, the system broadcast of the first PSAM card status changing, and writing the second preset value into the first preset device node, so as to notify the system driver to control the switching circuit of the common card slot to switch and connect to the application processor; and
Step B4, updating, by the SystemUI module, when receiving the system broadcast of the first PSAM card status changing, the display status of the first PSAM card icon in the status bar of the terminal device.

5. The method according to claim 1, wherein in the Step A2, it further comprises: performing identification and access of the SIM card, when obtaining a correct SIM card status through parsing.

6. The method according to claim 1, wherein further comprising: registering and listening to, by the SystemUI module, the system broadcast of the first PSAM card status changing, when initialized;
and the method further comprises: automatically calling cack, by the Telephony service module, a broadcast receiving method in an implementation of a preset custom interface class of the SystemUI module, after sending the system broadcast of the first PSAM card status changing.

7. The method according to claim 6, wherein the organizing the system broadcast of the first PSAM card status changing comprises: creating an Intent, specifying an action of the Intent, encapsulating a data structure, and depositing a key-value pair of the first PSAM card status into the data structure;
the registering and listening to the system broadcast of the first PSAM card status changing is specifically that: registering and listening to the Intent of the specified action;
the method further comprises: obtaining, by the SystemUI module, the Intent of the specified action, when the broadcast receiving method is called, and obtaining the first PSAM card status from the key-value pair of the first PSAM card status of the Intent by calling a system method.

8. The method according to claim 6, wherein the implementation of the preset custom interface class of the SystemUI module inherits from the broadcast, and a first member variable, a first PSAM status view, of the preset custom interface class comprises a first icon status of an inner class, and the first icon status comprises a first attribute and a second attribute, the first attribute controls whether to display an attribute of the first PSAM card icon, the second attribute controls an attribute of a first PSAM card icon style, and the first PSAM status view also comprises an update icon method;
updating, by the SystemUI module, the display status of the first PSAM card icon in the status bar of the terminal device is specifically comprises: calling the update icon method, updating the first attribute and the second attribute of the first icon status according to the first PSAM card status.

9. The method according to claim 1, wherein the Step A7 further comprises: updating, by a system Settings module, a status of a PSAM card switch menu, when receiving the system broadcast of the first PSAM card status changing.

10. The method according to claim 9, wherein after the Telephony service module receives the first PSAM card status, it further comprises saving the first PSAM card status;
the method further comprises: obtaining, when the system Settings module is initialized, the first PSAM card status saved by the Telephony service module from the Telephony service module, and determining the status of the PSAM card switch menu according to the obtained the first PSAM card status.

11. The method according to claim 10, wherein further comprising: performing the following steps when a user operates the PSAM card switch menu to disable the PSAM card:
Step C1, sending, by the system Settings module, a PSAM card disable notification to the Telephony service module;
Step C2, updating, by the Telephony service module, the saved first PSAM card status to a fourth preset status, organizing and sending the system broadcast of the first PSAM card status changing, and writing a second preset value to the first preset device node, so as to notify the system driver to control the switching circuit of the common card slot to switch and connect to the application processor; and
Step C3, updating, by the SystemUI module, when receiving the system broadcast of the first PSAM card status changing, the display status of the first PSAM card icon in the status bar of the terminal device, and updating, by the system Settings module, the status of the PSAM card switch menu.

12. The method according to claim 10, wherein further comprising: performing the following steps when a user operates the PSAM card switch menu to enable the PSAM card:
Step D1, sending, by the system Settings module, a PSAM card enable notification to the Telephony service module;
Step D2, updating, by the Telephony service module, the saved first PSAM card status to a fifth preset status, organizing and sending the system broadcast of the first PSAM card status changing, and writing the first preset value into the first preset device node, so as to notify the system driver to control the switching circuit of the common card slot to switch and connect to the security processor; and
Step D3, updating, by the SystemUI module, when receiving the system broadcast of the first PSAM card status changing, the display status of the first PSAM card icon in the status bar of the terminal device, and updating, by the system Settings module, the status of the PSAM card switch menu.

13. The method according to claim 9, wherein further comprising: registering and listening to, by the system Settings module, the system broadcast of the first PSAM card status changing, when starting to display the PSAM card switch menu, after the Telephony service module sends the system broadcast of the first PSAM card status changing, calling a preset broadcast reception method of the system Settings module, receiving, by the system Settings module, the system broadcast of the first PSAM card status changing, obtaining the first PSAM card status in the system broadcast of the first PSAM card status changing; canceling listening to, by the system Settings module, the system broadcast of the first PSAM card status changing, when turning off a display of the PSAM card switch menu.

14. The method according to claim 9, wherein the system Settings module comprises a preset custom class for implementing the PSAM card switch menu, the preset custom class inherits from the system switch menu, and a custom inner class of the preset custom class comprises an update menu method;
updating, by the system Settings module, the status of the PSAM card switch menu specifically comprises: calling the update menu method, and updating the status of the PSAM card switch menu according to the first PSAM card status.

15. The method according to claim 1, wherein in the Step A5, passing the first PSAM card status to the Telephony service module specifically comprises: passing, by the terminal service module, the first PSAM card status to the Telephony service module through an update PSAM card status interface of a class of an external interface provided by the Telephony service module.

16. The method according to claim 1, wherein the terminal device further comprises at least one PSAM card-specific card slot, and the method further comprises performing the following steps when a card is inserted in or removed from the specific card slot:
Step E1, performing, by the PSAMReader module, the PSAM card detection, and sending a second PSAM card status through the serial port according to the detection result;
Step E2, passing, by the terminal service module, the second PSAM card status to the Telephony service module, when receiving the second PSAM card status through the serial port;
Step E3, organizing and sending, by the Telephony service module, a system broadcast of the second PSAM card status changing, after receiving the second PSAM card status; and
Step E4, updating, by the SystemUI module, a display status of a second PSAM card icon in the status bar of the terminal device, when receiving the system broadcast of the second PSAM card status changing.

17. A purchase secure access module PSAM card automatic identification and display device, wherein applied to a terminal device equipped with an application processor and a security processor, the terminal device comprises at least one common card slot for a PSAM card and a subscriber identity module SIM card, the device comprises:
a processor and a memory;
the memory, configured to store a computer program;
the processor, configured to invoke the computer program to perform the following steps:
Step A0, performing, by a Modem module, an identification operation of the SIM card, and reporting an identification status of the SIM card to a Telephony service module;
Step A1, receiving, by the Telephony service module, the identification status of the SIM card reported by the Modem module, and organizing and sending a system broadcast of a SIM card status changing;
Step A2, parsing, by a Telephone process module, the system broadcast of the SIM card status changing, after receiving the system broadcast of the SIM card status changing, creating a first preset device node in a file system when obtaining a first error SIM card status through parsing, writing a first preset value to the first preset device node, so as to notify a system driver to control a switching circuit of the common card slot to switch and connect to the security processor, and sending a message, that the first preset value has been written into the first preset device node, to a terminal service module;
Step A3, sending, by the terminal service module, an instruction to start a PSAM card detection through a serial port, after receiving the message that the first preset value has been written into the first preset device node;
Step A4, performing, by a PSAMReader module, the PSAM card detection, when receiving the instruction to start the PSAM card detection through the serial port, and returning a first PSAM card status through the serial port according to a detection result;
Step A5, passing, by the terminal service module, the first PSAM card status to the Telephony service module, when receiving the first PSAM card status through the serial port;
Step A6, organizing and sending, by the Telephony service module, the system broadcast of the first PSAM card status changing, after receiving the first PSAM card status;
Step A7, updating, by a SystemUI module, a display status of a first PSAM card icon in a status bar of the terminal device, when receiving the system broadcast of the first PSAM card status changing;
the Modem module, the Telephony service module, the Telephone process module, the terminal service module and the SystemUI module are arranged on the application processor, the PSAMReader module is arranged on the security processor; when the terminal device is powered on, the switching circuit of the common card slot is connected to the application processor by default.

18. An electronic device, wherein comprising: a processor and a memory;
the memory, configured to store a computer program;
the processor, configured to perform a method according to claim 1 by invoking the computer program.

19. A chip system, wherein comprising a processor and an interface;
the processor is configured to implement the method according to claim 1 through the interface.

20. A non-transitory computer-readable storage medium, wherein configured to store a computer program, when the computer program runs on a computer, the computer executes the method according to claim 1.
